(19) United States
(12) Patent Application Publication
(10) Pub. No.: US 2026/0106830 A1
(43) Pub. Date: Apr. 16, 2026

(54) CONGESTION CONTROL MARKING FOR IN-NETWORK COMPUTING

(71) Applicant: MELLANOX TECHNOLOGIES, LTD., Yokneam (IL)

(72) Inventors: Roee Levy Leshem, Tel Aviv (IL); Mark Douglas Hummel, Franklin, MA (US); Gregory Michael Thorson, Mequon, WI (US); Lion Levi, Yavne (IL); Itamar Rabenstein, Petach-Tiqwa (IL); Noam Michaelis, Kfar-Saba (IL); Ofir Klara Altshul, Herzliya (IL); Aviv Avraham Paxton, Petah Tikva (IL)

(21) Appl. No.: 18/916,564

(22) Filed: Oct. 15, 2024

(51) Int. Cl. H04L 47/125; H04L 43/16; H04L 47/122

(52) U.S. Cl. CPC H04L 47/125; H04L 43/16; H04L 47/122

(57) ABSTRACT

Systems, methods, and devices for performing computing operations and managing network congestion are provided. In one example, a device is described to include a processing unit that collects a plurality of messages and performs an operation as part of a collective operation on data contained in the plurality of messages, then generates an output message with a result of the operation performed on the data contained in the plurality of messages. The processing unit may further incorporate a congestion notification into the output message in response to at least one of the plurality of messages also containing a corresponding congestion notification.

### FIELD OF THE DISCLOSURE

The present disclosure is generally directed toward networking and, in particular, toward advanced computing techniques employing distributed processes as well as congestion control approaches for the same.

### BACKGROUND

Distributed communication algorithms, such as collective operations, distribute work amongst a group of communication endpoints, such as processes. A collective operation is where each instance of an application on a set of machines needs to transfer data or synchronize (communicate) with its peers. Each collective operation can provide zero or more memory locations to be used as input and output buffers.

Reduction is an operation where a mathematical or logical operation (e.g., min, max, sum, etc.) is applied on a set of elements. In an Allreduce collective operation, for example, each application process contributes a vector with the same number of elements and the result is the vector obtained by applying the specified operation on elements of the input vectors. The resultant vector has the same number of elements as the input and needs to be made available at all the application processes at a specified memory location.

### BRIEF SUMMARY

Modern computing and storage infrastructure use distributed systems to increase scalability and performance. Common uses for such distributed systems include: datacenter applications, distributed storage systems, and High-Performance Computing (HPC) clusters running parallel applications. While HPC and datacenter applications use different methods to implement distributed systems, both perform parallel computation on a large number of networked compute nodes with aggregation of partial results or from the nodes into a global result.

Many datacenter applications such as search and query processing, deep learning, graph and stream processing typically follow a partition-aggregation pattern. An example is the well-known MapReduce programming model for processing problems in parallel across huge datasets using a large number of computers arranged in a grid or cluster. In the partition phase, tasks and data sets are partitioned across compute nodes that process data locally (potentially taking advantage of locality of data to generate partial results. The partition phase is followed by the aggregation phase where the partial results are collected and aggregated to obtain a final result.

Collective communication is a term used to describe communication patterns in which all members of a group of communication end-points participate. For example, in case of Message Passing interface (MPI) the communication end-points are MPI processes and the groups associated with the collective operation are described by the local and remote groups associated with the MPI communicator.

Many types of collective operations occur in HPC communication protocols, and more specifically in MPI and SHMEM (OpenSHMEM). The MPI standard defines blocking and non-blocking forms of barrier synchronization, broadcast, gather, scatter, gather-to-all, all-to-all gather/scatter, reduction, reduce-scatter, and scan. A single operation type, such as gather, may have several different variants, such as scatter and scatterv, which differ in such things as the relative amount of data each end-point receives or the MPI data-type associated with data of each MPI rank (e.g., the sequential number of the processes within a job or group).

The performance of collective operations for applications that use such functions is often critical to the overall performance of these applications, as they limit performance and scalability. This comes about because all communication end-points implicitly interact with each other with serialized data exchange taking place between end-points. The specific communication and computation details of such operations depend on the type of collective operation, as does the scaling of these algorithms. Additionally, the explicit coupling between communication end-points tends to magnify the effects of system noise on the parallel applications using these, by delaying one or more data exchanges, resulting in further challenges to application scalability.

Performance of collective operations also depends upon network performance. For instance, the implementation of congestion control protocols is becoming increasingly important for collective operations and system implementing the same. Congestion management of packet traffic in the communication systems described herein is important as poor congestion control may significantly impact system performance.

Some congestion control techniques are used in the industry, such as a rate-based source adaptation algorithm for packet-switching network, in which binary notifications are sent to the sources, reflecting a positive or negative difference between the source rate and the estimated fair rate, and based on these notifications, the sources increase or decrease the transmit rate. Other congestion control approaches include the use of an Explicit Congestion Notification (ECN). For example, TCP and IP protocols have been expanded to include the use of ECNs in two bits of the IP header.

In in-network compute operations, a switch may perform some logic/arithmetic calculation over multiple packets arriving from multiple hosts. In such a scenario, the switch waits for messages that may arrive from different paths. As messages arrive, the switch may then reduce and aggregate the messages, then generate a new message that is a result of the reduction and/or aggregation. If one of the incoming messages cross a congested path and contained an ECN marking of congestion in the ECN field, that knowledge may be removed during the consumption of the incoming messages and the generation of the new message.

Embodiments of the present disclosure aim to preserve the knowledge of the congested path, even after execution of a reduction and/or aggregation operation. More specifically, embodiments of the present disclosure aim to improve switch/network performance for reduce and/or aggregation operations. In in-network compute operations, a node (e.g., a switch) may wait for messages to arrive from different paths before performing it's part of a reduce/aggregate operation. If one of the messages arrives at the via a congested path with ECN marking, that knowledge may be retained with the node performing the appropriate operation(s) and then incorporating a new ECN marking into a resultant message or packet. In this way, information related to a message traversing a congested path is preserved, even when a reduce or aggregation operation is performed. In accordance with at least some embodiments, the node performing the reduction and/or aggregation may account for the ECN field that appears on known packet formats and then reflect the same information from the ECN field of the received messages into an output message generated following the reduction and/or aggregation.

Illustratively, and without limitation, a device is disclosed herein to include: a network interface; and a processing unit coupled with the network interface, where the processing unit collects a plurality of messages received at the network interface and performs an operation on data contained in the plurality of messages that consumes the plurality of messages then generates an output message with a result of the operation performed on the data contained in the plurality of messages, where the processing unit further incorporates a congestion notification into the output message in response to at least one of the plurality of messages also containing a corresponding congestion notification.

In some embodiments, the operation includes at least one of a reduction operation and an aggregation operation.

In some embodiments, the operation is performed as part of a collective operation that is distributed across a plurality of devices.

In some embodiments, the collective operation includes at least one of an Allreduce collective operation and a reduce scatter operation.

In some embodiments, the processing unit includes at least one of a Central Processing Unit (CPU), a Graphics Processing Unit (GPU), and a Data Processing Unit (DPU).

In some embodiments, information contained in the congestion notification is produced based on information contained in the corresponding congestion notification of the at least one of the plurality of messages.

In some embodiments, a first message in the plurality of messages includes a first corresponding congestion notification, where a second message in the plurality of messages includes a second corresponding congestion notification, and where the congestion notification incorporated in the output message retains information from both the first corresponding congestion notification and the second corresponding congestion notification.

In some embodiments, the congestion notification includes information provided in an Explicit Congestion Notification (ECN) field of the output message.

In some embodiments, the ECN field is provided in a header of the output message.

In some embodiments, the processing unit mirrors information from the corresponding congestion notification into the congestion notification.

In some embodiments, the congestion notification includes information describing a congested path that was traversed by the at least one of the plurality of messages.

In some embodiments, the processing unit collects the plurality of messages by aggregating the plurality of messages and then the processing unit determines that all messages associated with the operation have arrived, saves a state reflecting that the at least one of the plurality of messages also contained a corresponding congestion notification, and then updates the congestion notification of the output message to reflect the saved state.

According to at least some embodiments, a system is provided that includes: a device that is one of a plurality of devices performing a collective operation, where the device includes a processing unit that collects a plurality of messages and performs an operation as part of the collective operation on data contained in the plurality of message, then generates an output message with a result of the operation performed on the data contained in the plurality of messages, where the processing unit further incorporates a congestion notification into the output message in response to at least one of the plurality of messages also containing a corresponding congestion notification.

In some embodiments, the operation includes at least one of a reduction operation and an aggregation operation.

In some embodiments, the collective operation includes at least one of an Allreduce collective operation and a reduce scatter operation.

In some embodiments, the processing unit includes at least one of a Central Processing Unit (CPU), a Graphics Processing Unit (GPU), and a Data Processing Unit (DPU).

In some embodiments, information contained in the congestion notification is produced based on information contained in the corresponding congestion notification of the at least one of the plurality of messages.

In some embodiments, a first message in the plurality of messages includes a first corresponding congestion notification, where a second message in the plurality of messages includes a second corresponding congestion notification, and where the congestion notification incorporated in the output message retains information from both the first corresponding congestion notification and the second corresponding congestion notification.

In some embodiments, the congestion notification includes information provided in an Explicit Congestion Notification (ECN) field of the output message.

In some embodiments, the congestion notification includes information describing a congested path that was traversed by the at least one of the plurality of messages.

According to at least some embodiments, a device is provided that includes: a processing unit that collects a plurality of messages and performs an operation as part of a collective operation on data contained in the plurality of messages, then generates an output message with a result of the operation performed on the data contained in the plurality of messages, where the processing unit further incorporates a congestion notification into the output message in response to at least one of the plurality of messages also containing a corresponding congestion notification.

Additional features and advantages are described herein and will be apparent from the following Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1A is a block diagram illustrating a computing system in accordance with at least some embodiments of the present disclosure;

FIG. 1B is a block diagram illustrating one possible communication approach used by the computing system of FIG. 1A;

FIG. 1C is a block diagram illustrating another possible communication approach used by the computing system of FIG. 1A;

FIG. 1D is a block diagram illustrating another possible communication approach used by the computing system of FIG. 1A;

FIG. 2 is a block diagram illustrating details of a system in accordance with at least some embodiments of the present disclosure;

FIG. 3 illustrates a hierarchical tree in accordance with at least some embodiments of the present disclosure;

FIG. 4 is a block diagram illustrating additional details of a system in accordance with at least some embodiments of the present disclosure;

FIG. 5 is a block diagram illustrating details of a computational node in accordance with at least some embodiments of the present disclosure;

FIG. 6 is a flow diagram illustrating details of a first method in accordance with at least some embodiments of the present disclosure; and

FIG. 7 is a flow diagram illustrating details of a second method in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a Printed Circuit Board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means: A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material. ”

The terms “determine,” “calculate,” and “compute,” and variations thereof, as used herein, are used interchangeably and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

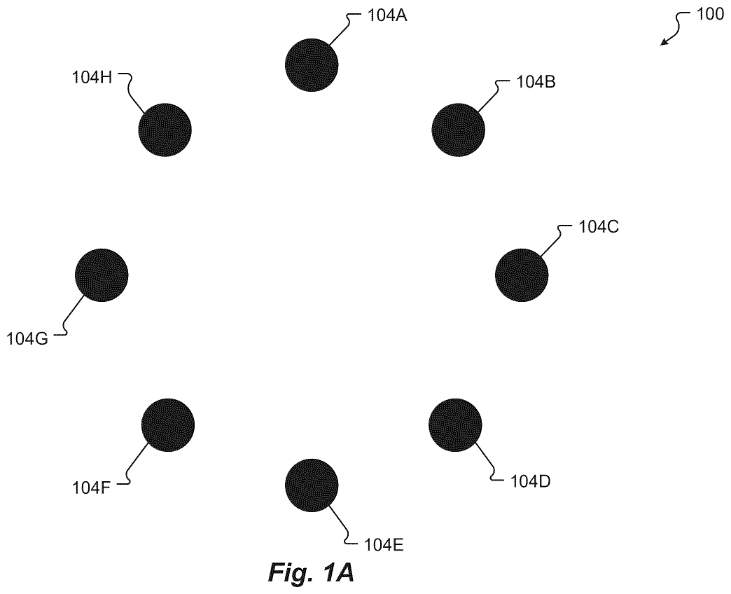

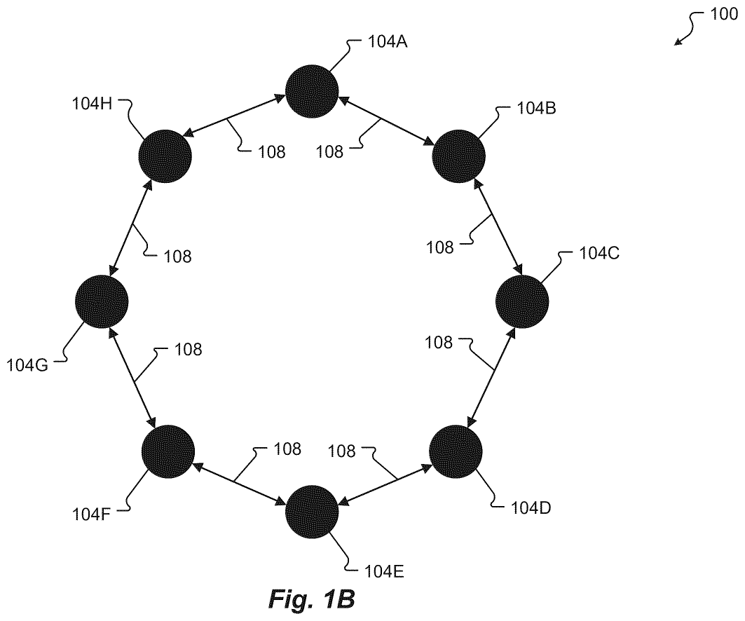

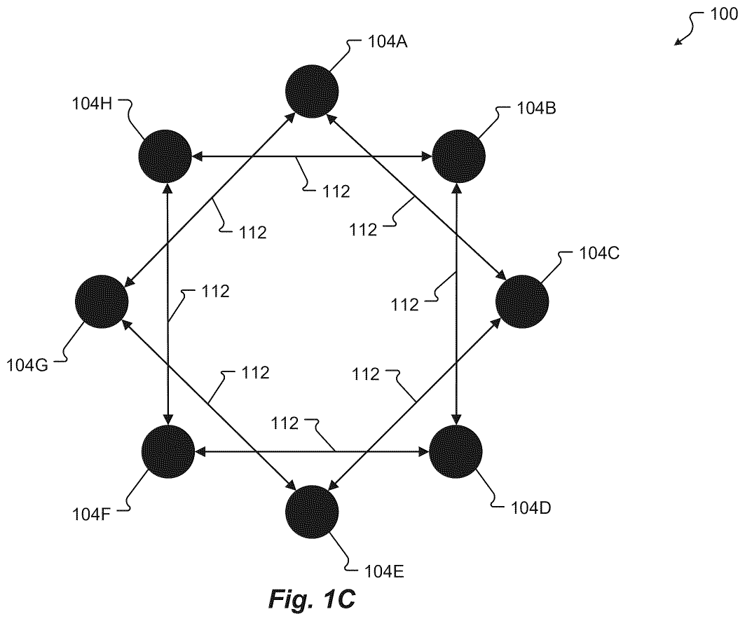

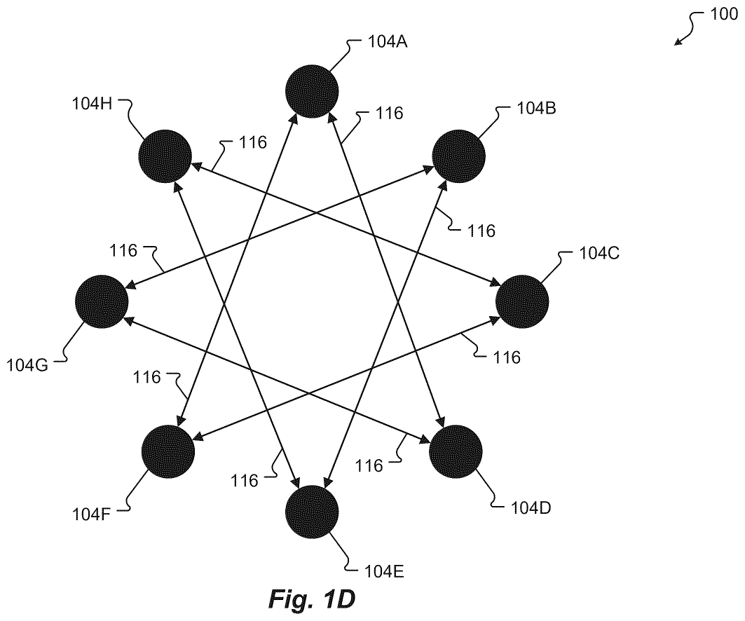

Referring now to FIGS. 1-7, various systems and methods for performing collective operations will be described in accordance with at least some embodiments of the present disclosure. While embodiments will be described in connection with particular operations (e.g., Allreduce, Iallreduce, Alltoall, Ialltoall, Alltoallv, Ialltoallv, Allgather, Scatter, Reduce, and/or Broadcast), it should be appreciated that the concepts and features described herein can be applied to any number of operations, including collective operations. Indeed, the features described herein should not be construed as being limited to the particular types of collective operations depicted and described.

While concepts will be described herein with respect to managing congestion in connection with the performance of operations, such as collective operations, it should be appreciated that the claims are not so limited. Rather, embodiments of the present disclosure are contemplated to apply to operations other than collective operations and may be used for purposes other than managing network congestion.

Referring initially to FIG. 1A, an illustrative system 100 is shown in which members/processes/endpoints are organized into a collective. The collective shown in FIG. 1A includes multiple endpoints 104 (e.g., network elements or other devices) that all contribute computing resources (e.g., processing resources and/or memory resources) to the collective. As used herein, an endpoint 104 may be, include, or incorporate at least one of a GPU, a CPU, a DPU, or the like. For example, the system 100 may include a first endpoint 104A, a second endpoint 104B, a third endpoint 104C, a fourth endpoint 104D, a fifth endpoint 104E, a sixth endpoint 104F, a seventh endpoint 104G, and an eight endpoint 104H, that form the collective and contribute computing resources to the collective. While eight (8) endpoints 104 are included in the example of the collective illustrated in FIG. 1A-1D, the collective (and corresponding techniques described herein) may include any number of endpoints 104 (e.g., greater than or less than eight (8) endpoints).

In some embodiments, the system 100 and corresponding collective formed by the multiple endpoints 104 may represent a ring network topology, ring algorithm, ring exchange algorithm, etc. A ring algorithm may be used in a variety of algorithms and, in particular, for collective data exchange algorithms (e.g., such as MPI_alltoall, MPI_alltoallv, MPI_allreduce, MPI reduce, MPI_barrier, other algorithms, OpenSHMEM algorithms, etc.).

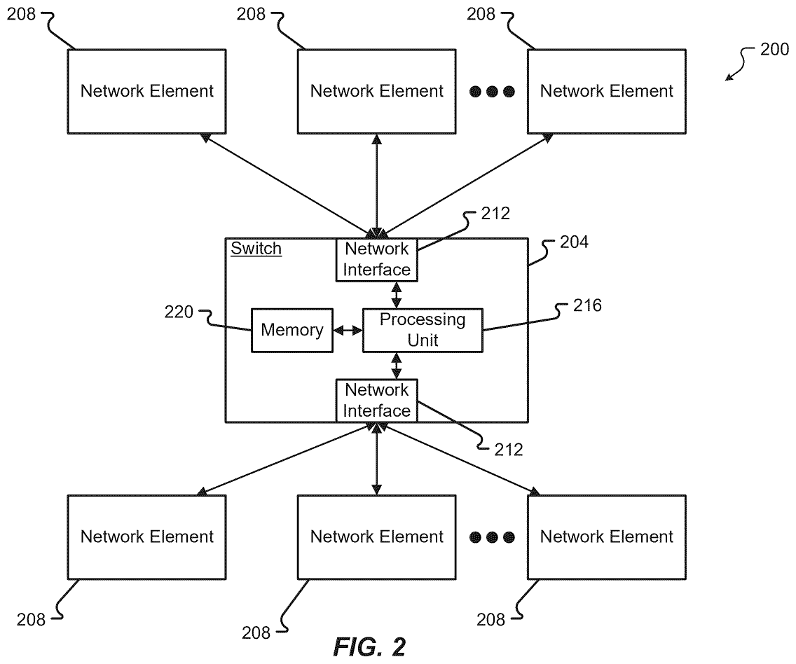

Additionally or alternatively, while FIG. 1A-1D and the techniques will be described in the example of a ring network topology or ring algorithm, the system 100 and corresponding collective may use any data exchange pattern that corresponds to a global communication pattern that implements algorithms that are collective in nature (e.g., all endpoints in a well-defined set of end-points participate in the collective operation). For example, the system 100 may comprise an ordered list of communication endpoints (e.g., the endpoints 104 are logically arranged in a structured order or pattern), where each endpoint 104 in the collective sends data to each other endpoint 104 (e.g., the data may be zero (0) bytes) and where each endpoint 104 in the collective receives data from each other endpoint 104 (e.g., the data may be zero (0) bytes). In some examples, the data exchange pattern and/or global communication pattern implemented by the collective may be referred to as an all-to-all communication pattern. As a more specific, but non-limiting example, the collective may be organized into a tree or hierarchical structure and results computed at one network element may be communicated up the tree to another network element, such as those illustrated in FIGS. 2-5.

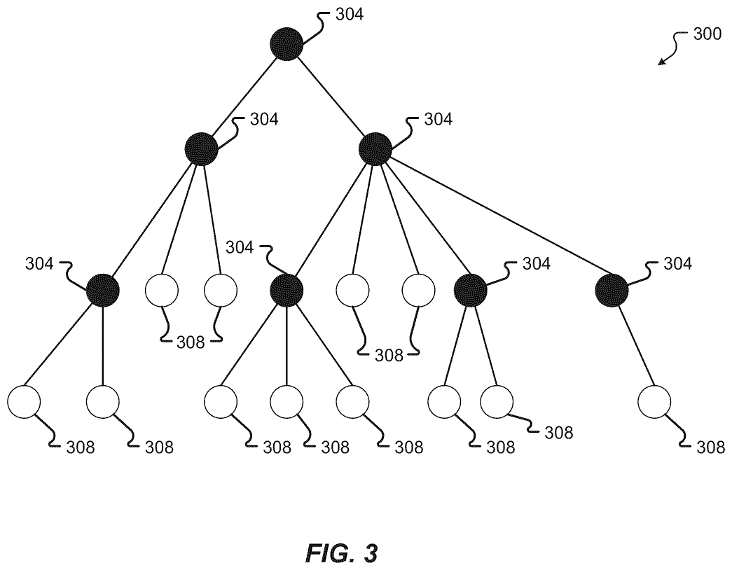

The hierarchical tree 300, as shown in FIG. 3, may include a network element designated as a root node, one or more network elements designated as vertex nodes, one or more network elements designated as leaf nodes. In some embodiments, the topology(ies) employed may not necessarily require a subnet manager. Embodiments of the present disclosure may provide an endpoint offload, and may be used with any suitable network fabric that supports an intelligent NIC as an endpoint (e.g., RoCE, HPE slingshot RoCE, etc.) or a GPU as an endpoint (e.g., with NVL packets).

All endpoints 104 of the collective may follow a fixed data exchange pattern of data exchange. In some examples, communication among the collective may be initiated with a subset of the endpoints 104. Accordingly, a fixed global pattern may be followed to ensure that one endpoint 104 will not reach a deadlock, and the data exchange is guaranteed to complete (e.g., barring system failures).

In the example of FIG. 1A, each endpoint 104 may be labeled (e.g., to represent their order in the collective and the fixed data exchange pattern). Additionally, each endpoint 104 may begin the collective by sending and receiving messages to themselves (e.g., each endpoint, Pi, sends and receives messages to/from Pi+0 and Pi−0). In the example of FIG. 1B, each endpoint 104 may participate in a data exchange 108 with a next ordered endpoint 104 in the collective. For example, each endpoint, Pi, may post a send message to a next ordered endpoint, Pi+1, and each endpoint, Pi, may post a receive to a preceding ordered endpoint, Pi−1. As an illustrative example, the first endpoint 104A (e.g., P1) may post a send message to the second endpoint 104B (e.g., P2) and may post a receive message to the eight endpoint 104H (e.g., P8) with wrap-around.

In the example of FIG. 1C, each endpoint 104 may participate in a data exchange 112 with a next ordered endpoint 104 in the collective, where the next ordered endpoint 104 is next in the collective and corresponding fixed data exchange pattern relative to the endpoint 104 of the data exchange 108 as described with reference to FIG. 1B. For example, each endpoint, Pi, may post a send message to a next ordered endpoint, Pi+2, and each endpoint, Pi, may post a receive to a preceding ordered endpoint, Pi−2. As an illustrative example, the first endpoint 104A (e.g., P1) may post a send message to the third endpoint 104C (e.g., P3) and may post a receive message to the seventh endpoint 104G (e.g., P7) with wrap-around.

In the example of FIG. 1D, each endpoint 104 may participate in a data exchange 116 with a next ordered endpoint 104 in the collective, where the next ordered endpoint 104 is next in the collective and corresponding fixed data exchange pattern relative to the endpoint 104 of the data exchange 112 as described with reference to FIG. 1C. For example, each endpoint, Pi, may post a send message to a next ordered endpoint, Pi+3, and each endpoint, Pi, may post a receive to a preceding ordered endpoint, Pi−3. As an illustrative example, the first endpoint 104A (e.g., P1) may post a send message to the fourth endpoint 104D (e.g., P4) and may post a receive message to the sixth endpoint 104F (e.g., P6) with wrap-around.

In some embodiments, the internal data exchange described in the example of FIG. 1A and the data exchanges 108, 112, and 116 may occur simultaneously or nearly simultaneously. Additionally or alternatively, a subset of the data exchanges may occur simultaneously or nearly simultaneously. Additionally or alternatively, the data exchanges may occur separately or independently. For example, Ns and Nr may dictate a number of data exchanges the endpoints 104 are capable of performing at a time. If Nr and Ns are equal to one (1) (e.g., each endpoint 104 can send/receive one message at a time), each of the data exchanges illustrated in the examples of FIGS. 1A, 1B, 1C, and 1D may occur consecutively (e.g., each data exchange is not performed until the preceding data exchange is completed).

As data is aggregated and forwarded (e.g., up the tree, around the ring, etc.), the data will eventually reach a destination node. The destination node may collect or aggregate data from other nodes in the collective and then distribute a final output. For instance, a root node may be responsible for distributing data to one or more specified reduction/aggregation tree destinations. In some embodiments, such reduction/aggregation trees may include a SHARP tree and the distribution of data within the SHARP tree may be performed per the SHARP specification. Additional details of the SHARP specification are provided in U.S. Pat. No. 10,284,383 to Bloch et al, the entire contents of which are hereby incorporated herein by reference. In some embodiments, data is delivered to a host in any number of ways. As one example, data is delivered to a next work request in a receive queue, per InfiniBand transport specifications. As another example, data is delivered to a predefined (e.g., defined at operation initialization) buffer, concatenating the data to that data which has already been delivered to the buffer. A counting completion queue entry may then be used to increment the completion count, with a sentinel set when the operation is fully complete.

As can be appreciated, data flows within the system 100 may be subject to network issues, such as congestion. In some embodiments, one or more of the endpoints 104 may be configured with functionality to report network congestion, detect network congestion, and retain information regarding network congestion, even after performing an operation, such as a collective operation that is distributed across a plurality of devices. In some embodiments, the operations performed by the endpoints 104 may include at least one of a reduction operation and an aggregation operation.

Referring now to FIG. 2-5, additional details of the components of the system 100 will be described in accordance with at least some embodiments of the present disclosure. As can be seen in FIG. 2, a system 200 is shown to include endpoints 104 in the form of a plurality of network elements 208 and at least one switch 204. In some embodiments, the network elements 208 may be configured to communicate with one another through (e.g., via) the switch 204.

The system 200 may include a networking having any suitable topology other than the one illustrated in FIG. 2. Said another way, a switch 204 may interconnect any number of network elements 208 or nodes. Exchange of data and data reduction among the network elements 208 are mediated by the switch 204, using various algorithms to implement data reduction.

The switch 204 may include one or more network interfaces 212, one or more processing units 216, and one or more memory devices 220. The network interface(s) 212 may provide a mechanism for connecting the switch 204 to a network cable or the like to support communications with other devices (e.g., the network elements 208). While the switch 204 is illustrated to utilize two different network interfaces 212 to support connectivity to different network elements 208, it should be appreciate that a single network interface 212 can be used to connect the switch 204 to all of the network elements 208 without departing from the scope of the present disclosure.

The network interface 212 may correspond to a networking card, network adapter, or the like that enables physical and logical connectivity between the switch 204 and other devices (e.g., a broader network). In some embodiments, the network interface 212 includes a Network Interface Controller (NIC). It should be appreciated, however, that the network interface 212 may support wireless communications with one or more other devices.

The processing unit 216 may correspond to a primary or main processing unit of the switch 204 that performs traditional tasks including the aggregation of messages from multiple network elements 208, the processing of messages from multiple network elements 208, and the preservation of congestion information contained in one or more of the messages received from one or more of the network elements 208. In some embodiments, the processing unit 216 may correspond to a Central Processing Unit (CPU) or collection of CPUs. The processing unit 216 may alternatively or additionally correspond to or include a Graphics Processing Unit (GPU), a Data Processing Unit (DPU), or other type of processing device.

The processing unit 216 may utilize memory 220 for the storage of data, the aggregation of data from various messages, and the like. The processing unit 216 may also read instructions from the memory 220 and execute such instructions to support functionality of the switch 204 as described herein.

In some embodiments, the processing unit 216 of the switch 204 is connected to processors of other network elements 208 through the network interface 212. In some embodiments, network interface 212 may be capable of supporting Remote Direct Memory Access (RDMA) such that the processing unit 216 and one or more other network-attached co-processors communicate with one another using RDMA communication techniques or protocols.

The types of tasks that may be performed in the processing unit 216 (or processing units of the other network elements 208) include, without limitation, application-level tasks (e.g., processing tasks associated with an application-level command, communication tasks associated with an application-level command, computational tasks associated with an application-level command, etc.), communication tasks such (e.g., data routing tasks, data sending tasks, data receiving tasks, etc.), and computational tasks (e.g., Boolean operations, arithmetic tasks, data reformatting tasks, aggregation tasks, reduction tasks, get tasks, etc.). Alternatively or additionally, the processing unit 216 may utilize one or more circuits to implement functionality of the processor described herein. In some embodiments, processing circuit(s) may be employed to receive and process data as part of the collective operation and/or congestion management functions. Processes that may be performed by processing circuit(s) include, without limitation, arithmetic operations, data reformatting operations, Boolean operations, etc.

The processing unit 216 may include one or more Integrated Circuit (IC) chips, microprocessors, circuit boards, simple analog circuit components (e.g., resistors, capacitors, inductors, etc.), digital circuit components (e.g., transistors, logic gates, etc.), registers, Field Programmable Gate Arrays (FPGAs), Application Specific Integrated Circuits (ASICs), combinations thereof, and the like. As noted above, the processing unit 216 may correspond to a CPU, GPU, DPU, combinations thereof, and the like.

In a first phase of a multi-phase operation, network elements 208 may be organized into hierarchical data objects referred to herein as “SHARP reduction trees” or “SHARP trees” that describe available data reduction topologies and collective groups. The leaves of a SHARP tree represent the data sources, and the interior junctions (vertices) represent aggregation nodes, with one of the vertex nodes being the root. Then, in a second phase, a result of a reduction operation is sent from the root to appropriate destinations. In some embodiments, reduction operations may rely on data received from a plurality of nodes.

Mapping a well-balanced reduction tree with many nodes onto an arbitrary physical topology includes finding an efficient mapping of a logical tree to a physical tree, and distributing portions of the description to various hardware and software system components. For general purpose systems that support running simultaneous parallel jobs, perhaps sharing node resources, one needs to minimize the overlap of network resources used by the jobs, thus minimizing the impact of one running job on another. In addition, it is desirable to maximize system resource utilization. In one way of reducing the impact of such setup operations on overall job execution time, a set of SHARP trees is created in advance for use by various jobs, whether the jobs execute sequentially or concurrently. Different jobs may share the same SHARP tree concurrently.

Individualized trees used for collective operations are set up for each concurrently executing job. The information required to define the collective groups is already known, because it was required in order to define the SHARP trees. Consequently, a group can be rapidly created by pruning the SHARP trees. The assumption is that collective groups are relatively long lived objects, and are therefore constructed once and used with each collective operation. This maps well to MPI and SHMEM use cases.

A SHARP tree represents one example of a reduction-tree. It is a general-purpose construct used for describing a scalable aggregation protocol, applicable to multiple use case scenarios. FIG. 3 illustrates one non-limiting example of a hierarchical tree 300, such as a SHARP tree or similar type of reduction-tree. The hierarchal tree 300 is composed of leaves representing data sources, internal nodes representing aggregation nodes, with the edges entering the junction representing the association of the children with the parent node. The hierarchical tree 300 of FIG. 3 is shown to include end nodes 308, which may also be referred to as “leaf nodes” that provide data to aggregation nodes 304.

The hierarchical tree 300 may correspond to a reduction tree, aggregation tree, or the like, such as a SHARP tree, which is a long-lived object, instantiated when the network is configured, and reconfigured with changes to the network. An implementation can support multiple SHARP trees within a single subnet. Setting up reduction trees that map well onto an arbitrary underlying network topology is costly, both in terms of setting up the mappings, and in distributing the mapping over the full system. Therefore, such setup is typically infrequent. Reduction trees, by their nature are terminated at a single point (their root in the network), and might span a portion of the network or the entire network. It should be appreciated that tree setup may also be dynamic. Regardless of the nature of tree setup (e.g., static or dynamic), embodiments of the present disclosure contemplate that congestion control solutions as provided herein can be used to improve the overall performance of devices in the tree.

To utilize available network resources well, and to minimize the effects of concurrently executing jobs on one another, one can define several reduction trees and at job initialization select the best matching tree to use. The SHARP trees are created and managed by a centralized aggregation manager. The aggregation manager is responsible for setting up SHARP trees at network initialization and configuration time and normally the trees are updated only in a case of topology change. While SHARP trees should be constructed in a scalable and efficient manner, they are not considered to be in an application performance critical path, i.e., a dependency graph that can be drawn for all the critical resources required by the application. Algorithmic details of tree construction are known and are outside the scope of this disclosure.

Each of the aggregation nodes 304 may implements a tree database supporting at least a single entry. The database is used to look up tree configuration parameters to be used in processing specific reduction operations. In order to reduce latency and improve performance, each of the aggregation nodes 304 has its own copy of the database. Also to address the issues associated with congestion within the system, one, some, or all of the aggregation nodes 304 may implement congestion control functionality. As an example, each aggregation node 304 may be configured to report the receipt of congestion information received from other nodes. The aggregation nodes 304 may also be configured to preserve congestion information after an operation has been performed on one or multiple messages received from other nodes. The preservation of congestion information even after performance of a collective operation helps to make other nodes in the system aware of possible network issues.

In some embodiments, each aggregation node 304 may have its own context, comprising local information that describes the SHARP tree connectivity including: its parent aggregation node and a list of its child nodes, both child aggregation nodes 304 and end nodes 308. The local information includes an order of calculation to ensure reproducible results when identical operations are performed.

An aggregation collective group describes a physical correspondence of vertices and leaves with aggregation nodes that are associated with a given reduction operation. Network resources are associated with aggregation groups. For example, the leaves of a collective group may be mapped to an MPI communicator, with the rest of the elements being mapped to switches.

With further reference to FIG. 3, specific reduction operations apply to data sources on a subset of the system nodes (e.g., end nodes 308). Therefore, for each such reduction operation a subset of the hierarchical tree 300 that includes these end-nodes needs may be created. For performance reasons, mapping of the physical resources that are required for the reduction operation is expected to follow the network's physical topology. Although not required, such mapping facilitates efficient use of physical link bandwidth and using the most compact tree for linking the leaves to the root, thus optimizing resource utilization.

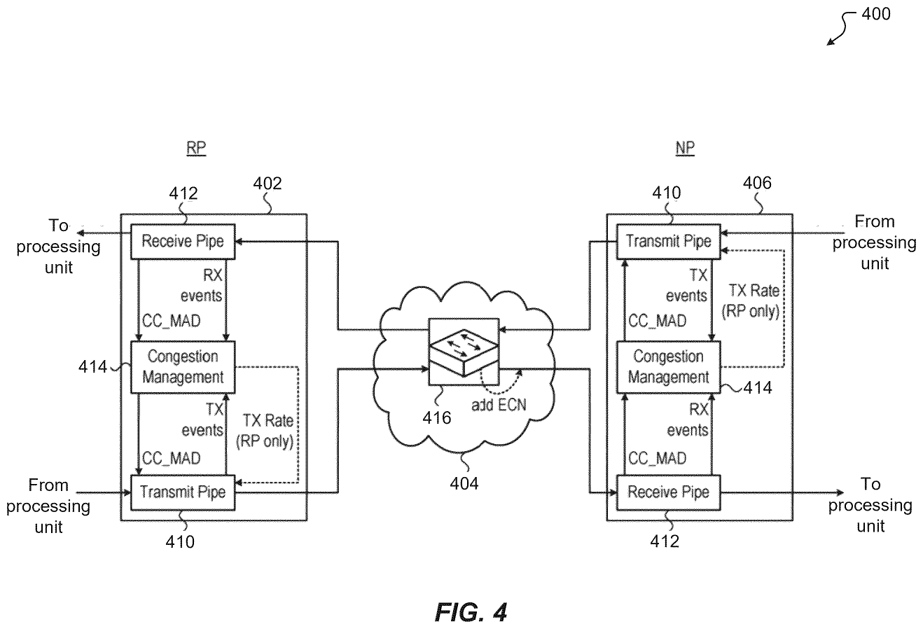

As noted above, congestion management may correspond to an important aspect of the functions performed in the system. FIG. 4 illustrates additional details of the functionality of nodes in the system 400 to support congestion management even when collective operations are being performed. The system 400 is illustrated as a Remote Direct Memory Access (RDMA) over Converged Ethernet (RoCE) communication system supporting congestion mitigation. It should be appreciated that embodiments of the present disclosure are not limited to the particular configuration of the system 400 illustrated in FIG. 4. Rather, embodiments of the present disclosure can be deployed or utilized in any suitable network topology or set of network topologies.

The system 400 is shown to include a transmitting node 402 that transmits packets over a network 404 to a receiving node 406. Both the transmitting node 402 and receive node 406 may be configured as a transmitting Network Adapter and receiving Network Adapter, respectively. In some embodiments, both the transmitting node 402 and receiving node 406 are configured to both transmit and receive packets; the terms “transmitting” and “receiving” hereinabove refer to the direction in which congestion is mitigated. According to the example embodiment illustrated in FIG. 4, the transmitting node 402 and receiving node 406 may be similar or identical devices, but may be differently configured within the context of a hierarchical tree 300.

Each of transmitting node 402 and receiving node 406 may include a transmit (TX) pipe 410, which queues and arbitrates packets that the node transmits; a receive (RX) pipe 412, which receives incoming packets from the network, and a congestion management unit 414.

In some embodiments, transmit pipe 110 of the transmitting node 402 may queue and arbitrate egress packets, as well as send the packets over network 404. The egress packets may originate, for example, from a processing unit that is coupled to the network-adapter, or from the congestion management unit 414.

The network 404 may include, according to the example embodiment illustrated in FIG. 4, a switch 416, which, when congested, may mark packets that the transmitting Network Adapter sends with an Explicit Congestion Notification (ECN). Although the congestion management unit 414 is shown as being exclusively contained in the nodes 402, 406, it should be appreciated that the switch 416 may also contain a congestion management unit 414. The switch 416 may be similar or identical to switch 204. The congestion management unit 414, particularly when contained within the switch 416, may be contained in the processing unit 216 or may correspond to instructions stored in memory 220 that are executable by the processing unit 216. It should be appreciated that some or all nodes of the system may be provided with a congestion management unit 414 without departing from the scope of the present disclosure. More specifically, one, some, or all of the nodes in the hierarchical tree 300 may include a congestion management unit 414 without departing from the scope of the present disclosure.

In operation, the receiving node 416 may send return packets back to the transmitting node 402, including packets that are used for congestion control such as CNP packets, ACK/NACK packets, RTT measurement packets and Programmable Congestion Control (CC) packets. When the receiving node 406 receives a packet with ECN indication, the receiving node 406 may send a CNP packet back to the sending node 402.

Congestion management unit 414 may be configured to execute congestion control algorithms, initiate sending of congestion control packets, maintain congestion control packets, and/or mitigate congestion in the RoCE transmit path. Congestion management unit 414 may receive Tx events when transmit pipe 404 sends bursts of packets, and Rx events when receive pipe 412 receives congestion notification packets. The received congestion notification packets may include, for example, ACK and NACK that are received in response to transmitted packets, CNP packets that the receiving Network Adapter generates in response to receiving ECN-marked packets, RTT measurement packets and congestion control packets.

The congestion control circuitry (e.g., as part of the congestion management unit 414) incorporated in the transmitting node 402, the receiving node 406, and/or the switch 416 may be configured to handle congestion events and runs congestion control algorithms. To mitigate congestion in a RoCE network protocol (or in other suitable protocols), a device (e.g., network adapter or switch) may comprise congestion management circuits, which collects a plurality of messages received at a network interface and performs an operation on data contained in the plurality of messages that consumes the plurality of messages then generates an output message with a result of the operation performed on the data contained in the plurality of messages. The device may further be configured to incorporate a congestion notification into the output message in response to at least one of the plurality of messages also containing a corresponding congestion notification.

As should be appreciated, the configuration of RoCE architecture 400 is an example configuration that is depicted purely for the sake of conceptual clarity. Other suitable configurations may be used in alternative embodiments of the present invention. For example, instead of (or in addition to) RoCE, the architecture may be TCP and/or converged Non-Volatile-Memory (NVM) storage (e.g., hyper-converged NVM-f).

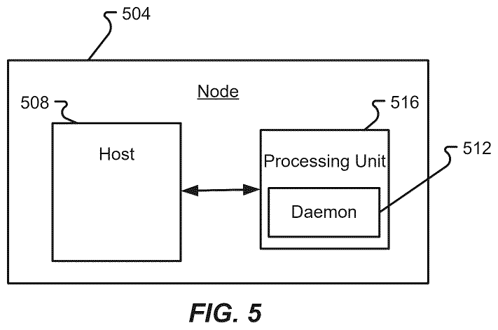

FIG. 5 illustrates additional details of a node 504 that may be implemented within a system. As a non-limiting example, the node 504 may correspond to a node 104, a network element 208, a switch 204, 416, aggregation node 304, network adapter 402, 406, or the like. The node 504 may include a host 508 and a processing unit 516. The processing unit 516 may correspond to an example of a processing unit 216. The processing unit 516 is shown to include a daemon 512. In some embodiments, the host 508 may be responsible for initializing the daemon 512. Once initialized, the host 508, processing unit 516, and daemon 512 contained within the processing unit 516 may enable the node 504 to perform various collective operations, manage network congestion, and perform other tasks as described herein.

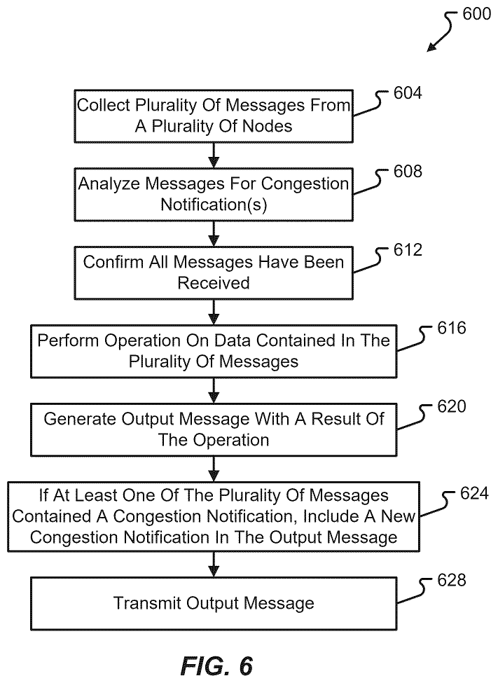

Referring now to FIG. 6, a first method 600 of operating a device, such as a node, switch, network adaptor, the like will be described in accordance with at least some embodiments of the present disclosure. The first method 600 may begin with the device collecting a plurality of messages from a plurality of other devices, such as other nodes in a collective (step 604). As an example, an aggregation node may collect a plurality of messages from a plurality of other nodes, which may include other aggregation nodes and/or end nodes 308.

As messages are received, the device may analyze the messages to determine if any of the messages contain a congestion notification (step 608). For example, the device may analyze the message(s) to determine if any of the messages contain an ECN or similar type of notification indicating an existence of network congestion.

The method 600 may continue when the device confirms that all messages needed to support the completion of an operation are received (step 612). In particular, the device may determine that all messages needed in connection with performing a collective operation have been received. Examples of a collective operation include a reduction operation, an aggregation operation, an Allreduce collective operation, a reduce scatter operation, or the like.

The method 600 may then proceed with the device performing the operation on the data contained in the messages that were collected (step 616). In some embodiments, the device may utilize data from each of the messages as inputs to the operation. Performance of the operation results in the device generating an output message with a result of the operation (step 620). For instance, the results of the operation may include data that was aggregated or reduced from the plurality of messages.

The method 600 may further include the device including a new congestion notification in the output message (step 624). In some embodiments, the incorporation of a new congestion notification in the output message may depend upon the analysis perform in step 608. Specifically, the device may incorporate a new congestion notification in the output message if at least one of the messages used for the collective operation included a congestion notification. The outcome of the congestion notification could follow any suitable logical or arithmetical operation on the incoming congestion notifications. For example, the device incorporating the new congestion notification could set the ECN high to indicate congestion if more than a predetermined amount or proportion of input messages (e.g., one-third, half, two-thirds, all, etc.) contain congestion marking. In some embodiments, information contained in the new congestion notification is produced based on information from the congestion notification that was in the received message. As a more specific example, if the device received two messages with two different congestion notifications, then the new congestion output message may include information from both of the two different congestion notifications. In this way, the output message may have a congestion notification that retains information from each congestion notification contained in the received messages.

The method 600 may further continue when generation of the output message is complete. Specifically, the device may transmit the output message to another device in the system (step 628). For example, the aggregation node may transmit the output message to another node in a hierarchical tree or some other node that is part of an operational collective.

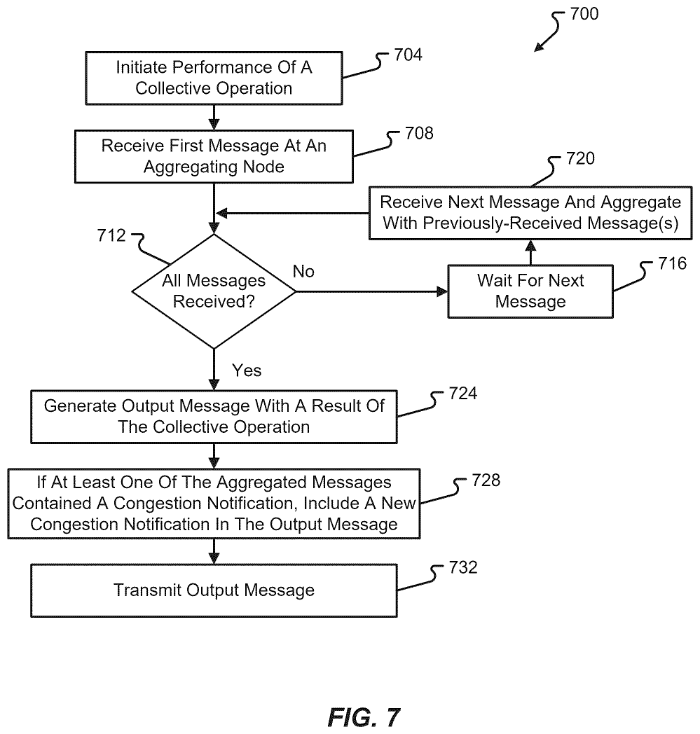

With reference now to FIG. 7, a second method 700 will be described in accordance with at least some embodiments of the present disclosure. The method 700 may include one or more steps that may be performed in addition to or in lieu of steps described in method 600. In other words, steps from method 600 and 700 may be combined or substituted for one another as appropriate and without departing from the scope of the present disclosure.

The method 700 may begin with the formation of a collective and an initiation of a collective operation within the collective (step 704). The method 700 may further continue when a first message is received at a device that is part of the collective (step 708). For instance, the first message may be received at an aggregation node.

The method 700 may then continue with the aggregation node determining whether or not all messages required to complete the collective operation have been received (step 712). If the answer to step 712 is answered negatively, then the device may wait for the next message (step 716). When the next message is received, the next message is aggregated with all previously received messages that are being used for the collective operation (step 720). The method 700 may then return back to step 712.

Once all message for the collective operation have been received, the method 700 continues with the aggregation node generating an output message with a result of the collective operation (step 724). The aggregation node may further include a new congestion notification in the output message if at least one of the messages received in step 708 or step 720 included a congestion notification (step 728). Congestion marking may be set for the generated message without connection to the aggregated messages. For example, congestion marking could also be utilized if the output queue of the switch is determined to be congested.

The output message, which may include results of the collective operation and the new congestion notification, may then be transmitted by the device (step 732). In some embodiments, the output message may be transmitted to another node in the collective.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A device comprising:
a network interface; and
a processing unit coupled with the network interface, wherein the processing unit collects a plurality of messages received at the network interface and performs an operation on data contained in the plurality of messages that consumes the plurality of messages then generates an output message with a result of the operation performed on the data contained in the plurality of messages, wherein the processing unit further incorporates a congestion notification into the output message in response to at least one of the plurality of messages also containing a corresponding congestion notification.

2. The device of claim 1, wherein the operation comprises at least one of a reduction operation and an aggregation operation.

3. The device of claim 1, wherein the operation is performed as part of a collective operation that is distributed across a plurality of devices.

4. The device of claim 3, wherein the collective operation comprises at least one of an Allreduce collective operation and a reduce scatter operation.

5. The device of claim 1, wherein the processing unit comprises at least one of a Central Processing Unit (CPU), a Graphics Processing Unit (GPU), and a Data Processing Unit (DPU).

6. The device of claim 1, wherein information contained in the congestion notification is produced based on information contained in the corresponding congestion notification of the at least one of the plurality of messages.

7. The device of claim 1, wherein a first message in the plurality of messages comprises a first corresponding congestion notification, wherein a second message in the plurality of messages comprises a second corresponding congestion notification, and wherein the congestion notification incorporated in the output message retains information from both the first corresponding congestion notification and the second corresponding congestion notification.

8. The device of claim 1, wherein the congestion notification comprises information provided in an Explicit Congestion Notification (ECN) field of the output message.

9. The device of claim 8, wherein the ECN field is provided in a header of the output message.

10. The device of claim 1, wherein the processing unit mirrors information from the corresponding congestion notification into the congestion notification.

11. The device of claim 1, wherein the congestion notification comprises information describing a congested path that was traversed by the at least one of the plurality of messages.

12. The device of claim 1, wherein the processing unit collects the plurality of messages by aggregating the plurality of messages and then the processing unit determines that all messages associated with the operation have arrived, saves a state reflecting that the at least one of the plurality of messages also contained a corresponding congestion notification, and then updates the congestion notification of the output message to reflect the saved state.

13. A system, comprising:
a device that is one of a plurality of devices performing a collective operation, wherein the device comprises a processing unit that collects a plurality of messages and performs an operation as part of the collective operation on data contained in the plurality of message, then generates an output message with a result of the operation performed on the data contained in the plurality of messages, wherein the processing unit further incorporates a congestion notification into the output message in response to at least one of the plurality of messages also containing a corresponding congestion notification.

14. The system of claim 13, wherein the operation comprises at least one of a reduction operation and an aggregation operation.

15. The system of claim 13, wherein the collective operation comprises at least one of an Allreduce collective operation and a reduce scatter operation.

16. The system of claim 13, wherein the processing unit comprises at least one of a Central Processing Unit (CPU), a Graphics Processing Unit (GPU), and a Data Processing Unit (DPU).

17. The system of claim 13, wherein information contained in the congestion notification is produced based on information contained in the corresponding congestion notification of the at least one of the plurality of messages.

18. The system of claim 13, wherein a first message in the plurality of messages comprises a first corresponding congestion notification, wherein a second message in the plurality of messages comprises a second corresponding congestion notification, and wherein the congestion notification incorporated in the output message retains information from both the first corresponding congestion notification and the second corresponding congestion notification.

19. The system of claim 13, wherein the congestion notification comprises information provided in an Explicit Congestion Notification (ECN) field of the output message.

20. The system of claim 13, wherein the congestion notification comprises information describing a congested path that was traversed by the at least one of the plurality of messages.

21. A device, comprising:
a processing unit that collects a plurality of messages and performs an operation as part of a collective operation on data contained in the plurality of messages, then generates an output message with a result of the operation performed on the data contained in the plurality of messages, wherein the processing unit further incorporates a congestion notification into the output message in response to at least one of the plurality of messages also containing a corresponding congestion notification.
